(19) United States
(12) Patent Application Publication
(10) Pub. No.: US 2006/0222915 A1
(43) Pub. Date: Oct. 5, 2006

(54) Direct-methanol fuel cell system and method for controlling the same

(76) Inventors: Hiroyasu Sumino, Tokyo (JP); Yasuhiro Harada, Yokohama-shi (JP); Hirohisa Miyamoto, Kamakura-shi (JP); Nobuo Shibuya, Hiratsuka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/389,090

(22) Filed: Mar. 27, 2006

(30) Foreign Application Priority Data
Mar. 31, 2005 (JP) 2005-101246

(51) Int. Cl. H01M 8/04

(52) U.S. Cl. 429/22; 429/23; 429/34; 429/13

(57) ABSTRACT

A direct-methanol fuel cell system includes a power generating unit, a fuel container which is connected to the power generating unit and contains a first fuel being a methanol aqueous solution, a replenishing container which is connected to the fuel container and contains a second fuel which is methanol or a methanol aqueous solution having a concentration higher than a concentration of the first fuel, and a control unit configured to reduce a concentration of the first fuel and a voltage of the power generating unit until a temperature of the power generating unit rises to a preset temperature value.

### CROSS-REFERENCE TO RELATED APPLICATIONS

This application is based upon and claims the benefit of priority from prior Japanese Patent Application No. 2005-101246, filed Mar. 31, 2005, the entire contents of which are incorporated herein by reference.

### BACKGROUND OF THE INVENTION

1. Field of the Invention

The present invention relates to a direct-methanol fuel cell (DMFC) system and a method for controlling the direct-methanol fuel cell system. The direct-methanol fuel cell system suitably drives electronic equipment such as small-sized portable equipment for a long time, the electronic equipment conventionally using primary batteries, secondary batteries, or the like as power sources.

2. Description of the Related Art

In recent years, the size of electronic equipment has been reduced to enable users to carry a large number of information terminals with them. Thus, society is being changed so that required information is available anywhere. On the other hand, these information terminals are equipped with a variety of functions such as a high-speed calculating process, a wireless LAN, and multimedia. This tends to increase power consumption. Batteries of large capacities are required to drive such information terminals for a long time. However, no batteries of necessary and sufficient capacities have been developed owing to environment and safety problems. Thus, there are growing expectations on fuel cells. Fuel cells using hydrogen ions (protons) obtained from methanol are called direct-methanol fuel cells. The direct-methanol fuel cells are increasingly expected to be applied to various fields as a power source for portable equipment for the following reasons: methanol, used as a fuel for the direct-methanol fuel cells, has a high energy density, and the direct-methanol fuel cells eliminate the need for a reformer, thus allowing their own sizes to be reduced.

The direct-methanol fuel cell starts generating power when a methanol fuel and air are supplied to its power generating unit. The direct-methanol fuel cell requires an anode to be supplied with a methanol fuel controlled to a predetermined concentration owing to use a specified polymer electrolyte membrane for the power generating unit. Consequently, direct-methanol fuel cells have been disclosed which have containers that accommodate specified amounts of methanol fuel. However, when the direct-methanol fuel cell is supplied with a methanol fuel of a controlled specified concentration as conventionally disclosed, a long time is required to increase the temperature of the power generating unit to a predetermined value. Thus, disadvantageously, a relatively long time is required to establish conditions for the stable supply of power required for the electronic equipment. Further, when the concentration of the methanol fuel is not adjusted using an optimum control method, an excessively large or small amount of fuel is consumed. This disadvantageously precludes the stable supply of power and degrades fuel utilization efficiency.

To increase the temperature of the power generating unit to the predetermined value quickly, Jpn. Pat. Appln. KOKAI No. 5-307970 discloses a method of intentionally supplying methanol to a cathode. However, this method requires piping through which methanol is supplied to the cathode and a mechanism that controls the amount of methanol supplied. This may complicate the structure of the cell and increase the size of the system. Moreover, if methanol is supplied to the cathode, a large quantity of heat is generated. Thus, it is disadvantageously difficult to control the temperature to the predetermined value.

Jpn. Pat. Appln. KOKAI No. 2004-55474 discloses a method of heating a methanol fuel before supplying it to the anode. However, this method also requires the fuel cell to have a mechanism for heating the fuel. This may also increase the size of the system.

Moreover, Jpn. Pat. Appln. KOKAI No. 61-269865 discloses a method for operating a fuel cell in which for start-up, the fuel cell is supplied with a fuel of a concentration higher than that for steady operations to accelerate the start-up. However, the concentration of the fuel is not precisely controlled during the start-up for reaching a steady operation. Thus, the fuel concentration decreases naturally as a result of power generation. Consequently, the following problems result: (1) The mere maintenance of a high fuel concentration increases a fuel loss. (2) The concentration of an initially introduced fuel must be adjusted on the basis of the size of an anolyte tank, power consumption, and the like, thus preventing the concentration from being flexibly controlled.

Furthermore, the output voltage of a direct-methanol fuel cell is about 0.5 V per membrane electrode assembly (MEA). To drive equipment, for example, a plurality of cells are stacked to achieve series connections to increase the voltage. The plurality of stacked cells rarely have the same characteristics. Some of these cells exhibit slightly low performances owing to the nonuniform distribution of the fuel or air. When output control is performed using a constant current density as disclosed in Jpn. Pat. Appln. KOKAI No. 61-269865, a large amount of current is forcibly outputted while the power generating unit is at low temperature. Then, voltage reversal occurs in cells with low performances. This results in problems such as a marked decrease in the voltage of the power generating unit and elution of metal ions from a catalyst layer. On the other hand, when a low current is continuously outputted in fear of the voltage reversal, problems result such as the degradation of fuel utilization efficiency and the need for a long time for raising the temperature. Therefore, during the start-up for reaching a steady operation, when the fuel temperature is low, it is necessary to make efforts to output a current while preventing the voltage reversal and to reduce the time required to change to the steady operation.

### BRIEF SUMMARY OF THE INVENTION

According to a first aspect of the present invention, there is provided a direct-methanol fuel cell system comprising:

a power generating unit including at least one membrane electrode assembly,

a fuel container which is connected to the power generating unit and contains a first fuel being a methanol aqueous solution,

a replenishing container which is connected to the fuel container and contains a second fuel which is methanol or a methanol aqueous solution having a concentration higher than a concentration of the first fuel, and

a control unit configured to reduce a concentration of the first fuel and a voltage of the power generating unit until a temperature of the power generating unit rises to a preset temperature value.

According to a second aspect of the present invention, there is provided a direct-methanol fuel cell system comprising a power generating unit including an anode, a cathode, and an electrolyte membrane provided between the anode and the cathode, the method comprising:

reducing a concentration of a first fuel supplied to the anode and a voltage of the power generating unit until a temperature of the power generating unit rises to a preset temperature value, and the first fuel being a methanol aqueous solution.

According to a third aspect of the present invention, there is provided a method for controlling a direct-methanol fuel cell system comprising:

a power generating unit including at least one membrane electrode assembly;

a fuel container which is connected to the power generating unit and contains a first fuel being a methanol aqueous solution; and

a replenishing container which is connected to the fuel container and contains a second fuel which is methanol or a methanol aqueous solution having a concentration higher than a concentration of the first fuel, and the method comprises reducing a concentration of the first fuel and a voltage of the power generating unit until a temperature of the power generating unit rises to a preset temperature value.

### BRIEF DESCRIPTION OF THE SEVERAL VIEWS OF THE DRAWING

FIG. 1 is a diagram showing the configuration of a direct-methanol fuel cell system in accordance with a first embodiment of the present invention;

FIG. 2 is a characteristic diagram showing the relationship between the following two differences in the direct-methanol fuel cell system: a difference between a preset temperature value and a current temperature and a difference between a current concentration and a preset concentration value;

FIG. 3 is a flowchart illustrating a method for correcting methanol replenishing amount in the direct-methanol fuel cell system in FIG. 1;

FIG. 4 is a schematic diagram showing an example of a power generating unit of the direct-methanol fuel cell system in FIG. 1; and

FIG. 5 is a plan view schematically showing a separator used for the power generating unit in FIG. 4.

### DETAILED DESCRIPTION OF THE INVENTION

A first embodiment of the present invention provides a direct-methanol fuel cell system. And a second embodiment of the present invention provides a method for controlling a direct-methanol fuel cell system.

According to the first and second embodiments, providing a direct-methanol fuel cell system which enables the temperature of a power generating unit to be increased to a preset value in a short time and which also enables an increase in the time for which power can be stably supplied to electronic equipment.

According to the first and second embodiments, the temperature of the power generating unit can be quickly increased to a predetermined value by optimally controlling the concentration of the fuel and the voltage of the power generating unit without the need to newly install a complicated mechanism. A direct-methanol fuel cell system can also be provided which enables an increase in the time for which power can be stably supplied to electronic equipment. At the same time, an appropriate amount of fuel can be supplied to improve the fuel utilization efficiency. Moreover, it is possible to provide a method for controlling the direct-methanol fuel cell system which method drives the direct-methanol fuel cell system more efficiently.

Here, the preset temperature value of the power generating unit is optimum for the operation of fuel cells. The preset temperature value may vary depending on the number of cells or the types of materials used for the electrodes and electrolyte membrane. The preset temperature value of the power generating unit desirably falls within a range of 50 to 90° C. when an anode catalyst and a cathode catalyst contain platinum and a perfluorosulfonic acid-based electrolyte is used as a proton conductive material contained in the anode, cathode, and electrolyte membrane. As a result, it is possible to prevent the activity of the anode and cathode catalysts from lowering, and it is possible to prevent the electrolyte membrane from thermal degradation. A more preferable range is 50 to 75° C.

The first and second embodiment will be described with reference to the drawings. The figures used for the description are shown illustratively to make the contents of the present invention understood. The figures do not limit the scope of the present invention.

FIG. 1 shows an example of configuration of the direct-methanol fuel cell system in accordance with the first embodiment of the present invention.

A power generating unit 1 comprises a plurality of unit cells each consisting of a membrane electrode assembly (MEA) and a plurality of separators in which a channel used to supply a fuel or air is formed, the unit cells and the separators being stacked so as to obtain a required voltage. The membrane electrode assembly comprises an anode, a cathode, and a proton conductive polymer electrolyte membrane placed between the anode and the cathode. The anode comprises, for example, a catalyst layer that serves to produce hydrogen ions (protons) from a methanol fuel by chemical reaction. The catalyst contains, for example, platinum ruthenium (PtRu)-containing alloy with little poisoning which may be unitarily used or may be carried on carbon powder. The catalyst used for the cathode contains, for example, platinum (Pt) particles that may be unitarily used or may be carried on carbon powder. A perfluorosulfonic acid-based polymer electrolyte membrane (for example, Nafion (registered trade mark) membrane) is applicable as the polymer electrolyte membrane owing to its high proton conductivity.

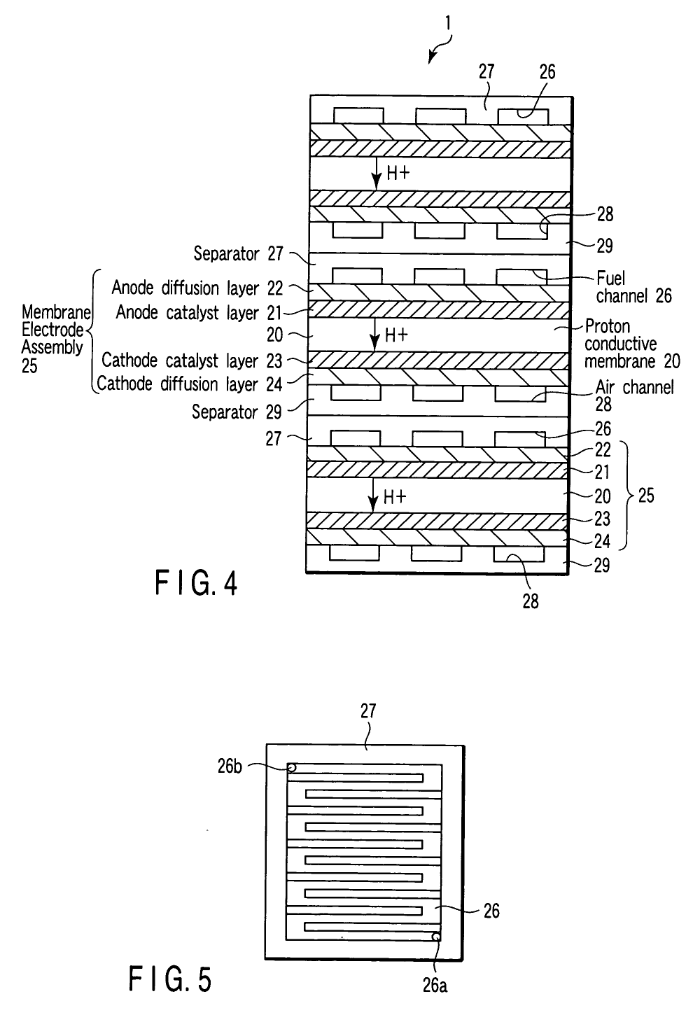

FIGS. 4 and 5 show an example of the power generating unit 1 formed of a plurality of membrane electrode assemblies (MEA). As shown in FIG. 4, an anode catalyst layer 21 and an anode diffusion layer 22 are formed on one surface of a proton conductive membrane 20. A cathode catalyst layer 23 and a cathode diffusion layer 24 are formed on the opposite surface of the proton conductive membrane 20. A separator 27 is placed on the anode diffusion layer 22 of each of the membrane electrode assemblies (MEA) 25; a fuel channel 26 is formed in the separator 27. As shown in FIG. 5, the fuel channel 26, formed in the separator 27, is of a serpentine type. One end of the fuel channel 26 functions as a fuel supply port 26a, whereas the other end functions as a fuel discharge port 26b. A separator 29 is placed on the cathode diffusion layer 24 of each of the membrane electrode assemblies (MEA) 25; an air channel 28 is formed in the separator 29. The air channel 28 is also of a serpentine type, and one end of the air channel 28 functions as an air supply port, whereas the other end functions as an air discharge port. The power generating unit 1 is formed by stacking a plurality of membrane electrode assemblies (MEA) 25 each having the separators 27 and 29 placed on the respective sides. When the power generating unit is constructed by stacking the plurality of membrane electrode assemblies via the separators as shown in FIGS. 4 and 5, separators may be used each of which has a fuel channel formed on one surface and an air channel formed on the other surface, in place of the separators each having the channel formed on one surface.

A methanol aqueous solution as a first fuel is accommodated in a fuel container 2. A supply port 2a in the fuel container 2 is connected to a fuel supply port 1a in the power generating unit 1 via a fuel supply pipe 3. A fuel pump 4 is provided for the fuel supply pipe 3. A fuel outlet 1b in the power generating unit 1 is connected to a recovery port 2b in the fuel container 2 via a fuel recovery pipe 5.

A high-concentration methanol tank 6 as a replenishing tank is connected to a fuel replenishing port 2c of the fuel container 2 via a fuel replenishing pipe 7. A fuel replenishing pump 8 is provided for the fuel replenishing pipe 7. The high-concentration methanol tank 6 accommodates a second fuel which is a methanol aqueous solution of a concentration higher than that of the methanol aqueous solution in the fuel container 2, or pure methanol.

A concentration sensor 9 can be installed in the fuel container 2 as shown in, for example, FIG. 1; the concentration sensor 9 detects the concentration of methanol in the methanol aqueous solution supplied to the anode. The concentration of methanol can be controlled by processing a signal for a detection result from the concentration sensor 9 and electrically reading the value. The methanol concentration sensor may utilize various systems which utilize optical refractive index, electrostatic capacity, or ultrasonic waves or which measure density or electrochemically detect a methanol oxidation current.

In FIG. 1, the concentration sensor 9 is placed inside the fuel container. However, the concentration sensor 9 may be installed in the supply port 2a or the fuel supply pipe 3 or in a branch pipe diverging from the fuel supply pipe 3.

Further, the temperature of the power generating unit 1 is measured by a temperature sensor 10 such as a thermistor or a thermocouple. For a power generating unit comprising a plurality of MEAs, the temperature sensor 10 desirably measures the temperature of a thickness-wise central portion of the separator located closest to the vicinity of center of the power generating unit across the height (in the direction in which MEAs are stacked).

An air pump 11 is connected to an air intake 1c in the power generating unit 1 via an air supply pipe 12. A condenser 13 is connected to an exhaust port 1d in the power generating unit 1 via a pipe 14. Air discharged from the exhaust port 1d is contaminated with moisture resulting from power generating reaction. The condenser 13 cools the air to convert the moisture into a liquid to separate it from the gas. The separated water is collected in the fuel recovery pipe 5 through a pipe 15. The fuel cell system preferably has a water recovery mechanism. Because a specified proton conductive material is used for the polymer electrolyte membrane, a methanol aqueous solution of concentration several to about 10% is preferably fed to the power generating unit. The fuel cell system preferably has a mechanism that recovers and reuses water. This mechanism increases the concentration of methanol inside the high-concentration methanol tank 6. In this case, the size of the tank can be reduced compared to that required when a methanol aqueous solution of a lower concentration is accommodated in the tank, which is driven for the same period. On the other hand, the remaining air is released to the exterior through an exhaust pipe 16.

The control unit has a function for reducing the concentration of the methanol aqueous solution in the fuel container 2 and the preset voltage value of the power generating unit 1 in accordance with a decrease in the difference between the temperature of the power generating unit 1 measured by the temperature sensor 10 and the preset temperature value of the power generating unit 1. The control unit comprises a monitor and control circuit 17, control software 18, and a circuit unit 19.

The concentration sensor 9 and the temperature sensor 10 are connected to the monitor and control circuit 17. Signals for measurements from the sensors 9 and 10 are processed by the monitor and control circuit 17. The control software 18 processes information obtained from the monitor circuit 17 and provides required control signals to the control circuit 17. The control software 18 compares the temperature measured by the temperature sensor 10 and the operating temperature (preset temperature value) of the power generating unit used after the system has changed to a steady operation. The control software 18 then calculates the target concentration of methanol aqueous solution and the target voltage on the basis of the difference in temperature. The calculation is sent to the monitor and control circuit 17. The concentration of methanol aqueous solution in the fuel container 2 decreases gradually because methanol is consumed as power is generated. When the concentration sensor 9 detects a decrease in concentration, the monitor and control circuit 17 transmits a signal to cause the fuel replenishing pump 8 to replenish the fuel container 2 with the second fuel from the high-concentration methanol tank 6.

The circuit unit 19 monitors the voltage and the current through the power generating unit 1. A signal for a monitor result is sent to the control circuit 17, which then processes the signal. The monitor and control circuit 17 compares the current voltage value and a target voltage value calculated by the control software 18. If the values are different, the monitor and control circuit 17 sends a signal to the circuit unit 19, which then changes the current voltage to be equal to the target voltage value.

The operation of the fuel cell system will be described below.

The fuel pump 4 is driven to supply the methanol aqueous solution in the fuel container 2 to the fuel supply port 1a in the power generating unit 1 through the fuel supply pipe 3. Further, the air pump 11 is driven to supply air to the air intake 1c in the power generating unit 1 through the air supply pipe 12. This causes power generating reaction.

A liquid component containing methanol unused for power generation is discharged from the fuel outlet 1b in the power generating unit 1. The methanol is collected in the fuel container 2 through the fuel recovery pipe 5 and then the recovery port 2b in the fuel container 2. On the other hand, a gas component containing air unused for power generation is supplied from the exhaust port 1d to the condenser 13 through the pipe 14. The condenser 13 then cools the gas component. This enables water mixed in the gas component to be converted back into a liquid to separate it from the gas. The separated water is fed from the pipe 15 to the fuel recovery pipe 5 and then collected in the fuel container 2. The gas is released to the exterior through the exhaust pipe 16.

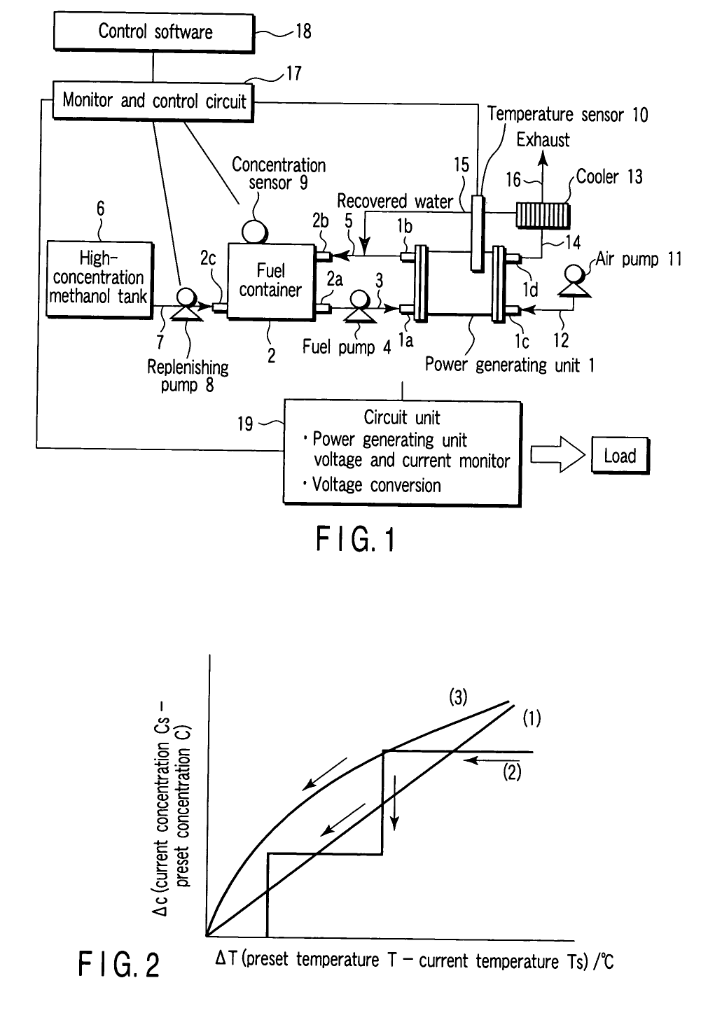

While the temperature of the power generating unit 1 is being measured, the concentration of methanol inside the fuel container 2 is controlled in association with the temperature of the power generating unit 1. FIG. 2 schematically shows a method for control. If the methanol operating concentration (preset concentration value) is to be controlled to a value C and the operating temperature (preset temperature value) of the power generating unit 1 is to be controlled to a value T, since a temperature Ts prior to operation is normally lower than the operating temperature T, the temperature of the power generating unit 1 must be increased from the temperature value Ts to T by start-up. If there is a large difference in temperature (T−Ts), the methanol concentration is intentionally controlled to the concentration Cs, which is higher than C, in order to urge heat generation. That is, ΔC (Cs−C) is increased consistently with ΔT (T−Ts). AC may be controlled so as to vary in association with ΔT as shown in FIG. 2. Besides the proportional relationship shown in (1), an appropriate method may be used, such as (2) a step-by-step variation or (3) a variation in accordance with a certain function.

Further, it is possible to maintain the methanol concentration Cs corresponding to the temperature of the power generating unit 1, at a fixed value or to vary the value within a certain narrow concentration range. The control unit is preferably configured to reduce the concentration of the first fuel to a preset concentration value C by alternately performing a first operation and a second operation until the temperature of the power generating unit 1 rises to the preset temperature value T. The first operation is one for reducing the concentration of the first fuel to a value Cs greater than the preset concentration value C. On the other hand, the second operation is one for maintaining the concentration of the first fuel at the value Cs by replenishing the fuel container 2 with the second fuel. Specifically, the temperature sensor 10 measures the temperature of the power generating unit 1. On the basis of the difference between the measured temperature and the preset temperature value, the control software 18 then calculates the control target methanol concentration Cs. The control software 18 then transmits an electric signal to the monitor and control circuit 17. When the concentration sensor 9 senses a decrease in the concentration of methanol aqueous solution in the fuel container 2, the monitor and control circuit 17 transmits a signal. As a result, the fuel replenishing pump 8 replenishes the fuel replenishing port 2c in the fuel container 2 with a required amount of the second fuel fed from the high-concentration methanol tank 6 through the fuel replenishing pipe 7. The control concentration is thus increased to Cs.

By thus supplying a higher-concentration methanol fuel to the power generating unit at a low temperature, it is possible to facilitate methanol crossover to a cathode, which can then burn methanol. This helps raise the temperature of the power generating unit. The temperature of the power generating unit thus increases more rapidly to make it possible to reduce the time required to obtain a required amount of power. Further, if the temperature rises and when the concentration is kept high, the temperature may rise excessively to damage the material of the power generating unit. This may shorten the lifetime of the power generating unit.

Accordingly, when an unexpectedly large amount of second fuel is replenished to increase the concentration above the desired value Cs to raise the temperature of the power generating unit 1, it is possible to stop replenishing the high concentration of methanol fuel for a specified time to wait for a natural decrease associated with power generation. Alternatively, for example, the amount of air blown against the condenser is increased to temporarily enhance the recovery capability of the condenser 13 to increase the amount of water recovered, thus diluting the first fuel. This alleviates damage to the cathode owing to crossover.

Moreover, to facilitate start-up, while preventing voltage reversal from occurring in a cell (MEA) in the power generating unit (stack) in which a plurality of cells (MEA) are stacked, the output voltage is gradually lowered in accordance with a rise in the temperature of the power generating unit during the start-up for reaching a steady operation. The temperature of the power generating unit rises to improve the activity of the catalyst contained in each cell. It is thus possible to output a larger amount of current than at low temperature even with the same voltage. Accordingly, the amount of current outputted from the power generating unit can be increased following the current-voltage characteristics of the power generating unit by controlling the operation of the power generating unit with a constant voltage and gradually lowering the constant voltage value as the temperature rises. An increase in the amount of output current increases the quantity of heat generated. This raises the temperature of the power generating unit, thus avoiding a fall in the temperature of the power generating unit caused by a decrease in the concentration of the first fuel.

Moreover, heat is expected to be generated by an increase in the amount of current achieved by controlling the voltage. Consequently, the temperature can be increased to the preset value in spite of a small difference between the first fuel concentration during the start-up and the first fuel concentration during the steady operation. The utilization efficiency of the fuel can be improved.

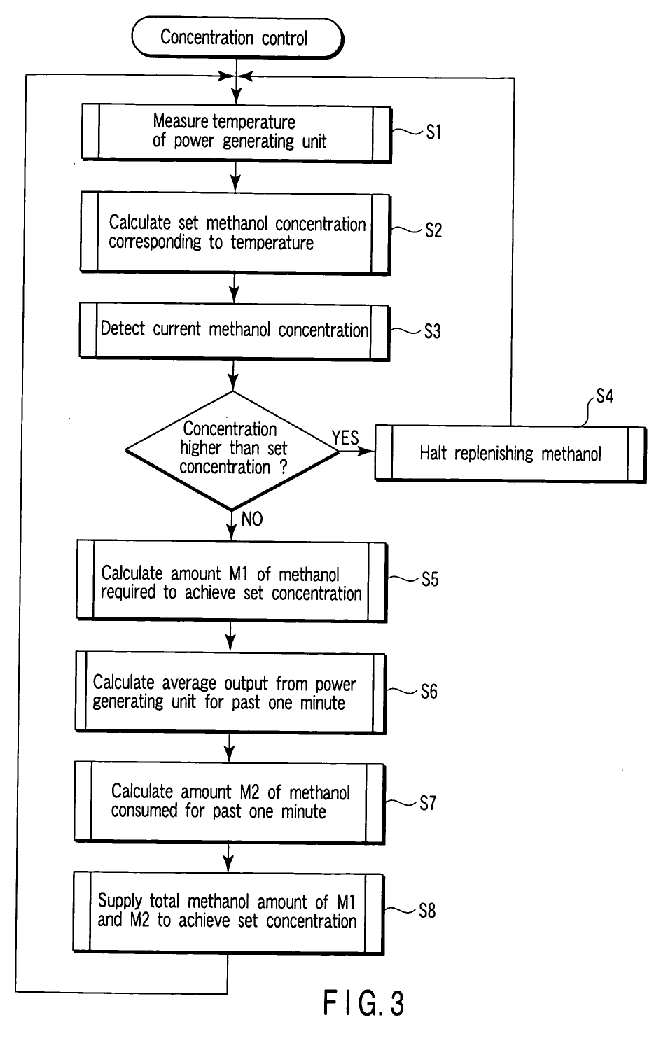

Further, when the concentration of the first fuel is adjusted and if the time intervals at which the second fuel is replenished are increased, the concentration may not be precisely controlled by replenishing an amount of the second fuel equal to the difference between the current measured concentration and the target concentration. To precisely control the concentration, it is desirable to replenish the fuel container 2 with the second fuel in an amount adjusted by an adjusting unit. Specifically, it is desirable to employ a method for controlling the methanol concentration Cs as illustrated below in FIG. 3.

As shown in FIG. 2, previously described, the power generating unit is supplied with a first fuel with a methanol concentration corresponding to the temperature of the power generating unit. However, a large deviation actually occurs between the preset concentration value and the current concentration. A large deviation may preclude the power generating state from being maintained to shut down the system, if the current concentration is low. With a high current concentration, extra methanol may cross over to the cathode to raise the temperature of the power generating unit. This may damage the material of the power generating unit to prevent the system from functioning. In this case, it is general to supply an amount of the second fuel equal to the difference from the preset concentration value. The fuel cell system desirably comprises an adjusting unit that corrects the amount of the second fuel to be replenished by calculating the amount of methanol consumed during a past predetermined time using the amount of power generated by the power generating unit. That is, first, the sensor measures the temperature of the power generating unit (step S1). Then, for example, the control software calculates the set methanol concentration corresponding to the measured temperature (step S2). The current methanol concentration can be measured by the concentration sensor installed in the fuel container or in the pipe to the anode or its branch (step S3). If the fuel methanol concentration measured by the concentration sensor is higher than the preset concentration value, the supply of the second fuel is stopped for a specified time (step S4). If the current concentration measured by the concentration sensor is lower than the preset concentration value, control is preformed so that the second fuel from the high-concentration methanol container is replenished.

First, the current methanol deficiency amount M1 can be calculated using, for example, the following equation (step S5):
M1(g)={(Ma(g/L)−Mb(g/L))×V(mL)}/1000(mL/L)

where Mₐ denotes the preset concentration value (g/L), M_{b} denotes the measured concentration (g/L), and V denotes the volume of the fuel container (mL).

Further, the average output (W) from the power generating unit during the past one minute is calculated (step S6). The amount M2 of methanol expected to be consumed for power generation for a specified time before replenishment can be calculated using, for example, the following equation (step S7):
M2(g)=(X(g/Wh)/60(min/h))×Y(W)

where X denotes a fuel consumption coefficient (g/Wh) and Y denotes the output (W) from the power generating unit during the past one minute.

The pump or the like is used to replenish an amount of the second fuel from the methanol container which corresponds to the sum of the calculations (M1+M2) (step S8). This enables power generation to be continued with the fuel concentration maintained at a predetermined value. The replenishment is often carried out by calculating only M1. A high output from the power generating unit increases the amount of methanol consumed during a specified time. Consequently, it is expected that the fuel concentration cannot be maintained at a predetermined value by replenishing M1, when the power generating unit operates at the high output. By correcting, before supply, the replenishment amount on the basis of the output from the power generating unit, it is possible to drive the direct-methanol fuel cell system more stably.

The methanol replenishment amount adjusting mechanism may be, for example, a metering pump that can dispense an accurate amount of liquid during one operation. The number of times the metering pump operates can be varied using the control software 18 and the control circuit 17.

The present invention will be described in detail by using examples to make it understood easily.

### EXAMPLE 1

A solution of perfluorosulfonic acid and ion-exchanged water were added to carbon black on which a platinum-ruthenium (Pt:Ru=1:1) alloy particles were supported as an anode catalyst. The catalyst-supported carbon black was dispersed to prepare a paste. Carbon paper subjected to a water repellent treatment was prepared as an anode diffusion layer. The paste was applied to the carbon paper, which was then dried to form a catalyst layer. An anode was thus obtained.

A solution of perfluorosulfonic acid and ion-exchanged water were added to carbon black on which platinum (Pt) particles were supported as a cathode catalyst. The catalyst-supported carbon black was dispersed to prepare a paste. Carbon paper subjected to a water repellent treatment was prepared as a cathode diffusion layer. The paste was applied to the carbon paper, which was then dried to form a catalyst layer. A cathode was thus obtained.

A perfluorosulfonic acid membrane was placed between the anode catalyst layer and the cathode catalyst layer as an electrolyte membrane. The electrodes and membrane were hot-pressed and thus assembled to obtain a membrane electrode assembly. The membrane electrode assembly was sandwiched between carbon separators having a fuel channel formed on one surface and an air channel formed on the other surface. Fifteen such sandwiched structures were stacked to form a power generating unit.

A fuel cell system similar to the one shown in FIG. 1 was constructed. The first fuel concentration was measured by the concentration sensor. Before measuring, the concentration sensor is supplied with a small amount of the first fuel from the fuel container using the pump. Power generation tests were conducted by setting the target operating temperature of the power generating unit at 60° C. and the operating concentration at 1.0 mol/L and using an electronic load to set a constant voltage mode. The concentration and voltage settings for the temperature of the room temperature (25° C.) to 60° C. were as shown in Table 1. The method for control shown in FIG. 3 was utilized to control the concentration within each temperature range. The temperature of the power generating unit rose to a desired steady operation temperature of 60° C. in about 20 minutes; the steady state was reached in a short time. The first fuel concentration could be controlled within the range of ±0.2 mol/L from the control value. Since the steady state could be reached in a short time and a variation in fuel concentration could be minimized, power can be generated with the temperature and output stabilized.

TABLE 1

| | Control | Control | |
|---|---|---|---|
| | temperature | concentration | Control voltage |
| | (° C.) | (mol/L) | (V) |
| Start-up | Less than 35° C. | 2.0 | 6.7 |
| Second stage | At least 35° C., | 1.5 | 6.4 |
| | less than 50° C. | | |
| Third stage | At least 50° C., | 1.2 | 6.2 |
| | less than 60° C. | | |
| Steady | At least 60° C. | 1.0 | 6.0 |
| operation | | | |

### EXAMPLE 2

The preset temperature value and voltage were similar to those used in Example 1. For the concentration control, the method shown in FIG. 3 was not used but a required amount of the second fuel was replenished which was equal to the difference between the concentration in the fuel container and the preset concentration value.

The concentration deviated instantaneously from the control value by at least 0.4 mol/L; the first fuel concentration varied slightly unstably. About 30 minutes, which was slightly longer than in Example 1, was required for start-up.

### EXAMPLE 3

A direct-methanol fuel cell was prepared which had a power generating unit in which 20 membrane electrode assemblies (MEA) were stacked. Power generation tests were conducted by setting the target operating temperature of the power generating unit at 55° C. and the operating concentration at 0.9 mol/L and using the electronic load to set the constant voltage mode. The concentration and voltage settings for the temperature of the room temperature (25° C.) to 55° C. were as shown in Table 2. The method for control shown in FIG. 3 was utilized to control the concentration within each temperature range. The temperature of the power generating unit rose to 55° C. in about 18 minutes. The first fuel concentration could be controlled within the range of ±0.2 mol/L from the control value. Since the steady state could be reached in a short time and a variation in first fuel concentration could be minimized, power can be generated with the temperature and output stabilized.

TABLE 2

| | Control | Control | |
|---|---|---|---|
| | temperature | concentration | Control voltage |
| | (° C.) | (mol/L) | (V) |
| Start-up | Less than 40° C. | 1.6 | 9.4 |
| Second stage | At least 40° C., | 1.4 | 8.8 |
| | less than 48° C. | | |
| Third stage | At least 48° C., | 1.1 | 8.4 |
| | less than 55° C. | | |
| Steady | At least 55° C. | 0.9 | 8.2 |
| operation | | | |

### COMPARATIVE EXAMPLE 1

The fuel cells were operated in the same manner as that used in Example 1 except that the control concentration was fixed at 1.0 mol/L for the entire temperature range. It took a longer time to reach the target temperature of 60° C. than in Examples 1 and 2; about 40 minutes was required to reach the target temperature. The first fuel concentration was controlled within the range of ±0.2 mol/L from the control value.

### COMPARATIVE EXAMPLE 2

The fuel cells were operated in the same manner as that used in Example 1 except that the control voltage was fixed at 6.5 V for the entire temperature range. It took a longer time to reach the target temperature of 60° C. than in Examples 1 and 2; about 45 minutes was required to reach the target temperature. The first fuel concentration was controlled within the range of ±0.2 mol/L from the control value.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A direct-methanol fuel cell system comprising:
a power generating unit including at least one membrane electrode assembly;
a fuel container which is connected to the power generating unit and contains a first fuel being a methanol aqueous solution;
a replenishing container which is connected to the fuel container and contains a second fuel which is methanol or a methanol aqueous solution having a concentration higher than a concentration of the first fuel; and
a control unit configured to reduce a concentration of the first fuel and a voltage of the power generating unit until a temperature of the power generating unit rises to a preset temperature value.

2. The direct-methanol fuel cell system according to claim 1, further comprising an adjusting unit configured to adjust an amount of the second fuel from the replenishing container replenished in the fuel container.

3. The direct-methanol fuel cell system according to claim 2, wherein the control unit is configured to reduce the concentration of the first fuel to a preset concentration value by alternately performing a first operation and a second operation, until the temperature of the power generating unit rises to the preset temperature value,
the first operation is one for reducing the concentration of the first fuel to a value greater than the preset concentration value, and the second operation is one for maintaining the concentration of the first fuel at the value by replenishing the fuel container with the second fuel in an amount adjusted by the adjusting unit.

4. The direct-methanol fuel cell system according to claim 3, wherein the adjusting unit is configured to calculate an amount of methanol to be consumed in power generation until the fuel container is replenished with the second fuel from the replenishing container in the second operation, and configured to correct the amount of the second fuel to be replenished in the second operation using the amount of methanol to be consumed.

5. The direct-methanol fuel cell system according to claim 1, wherein the preset temperature value falls within a range of 50 to 90° C.

6. The direct-methanol fuel cell system according to claim 1, wherein the preset temperature value falls within a range of 50 to 75° C.

7. The direct-methanol fuel cell system according to claim 1, wherein said at least one membrane electrode assembly comprises an anode, a cathode, and an electrolyte membrane provided between the anode and the cathode.

8. The direct-methanol fuel cell system according to claim 7, wherein the anode and the cathode contain a platinum-containing catalyst, and the electrolyte membrane is a perfluorosulfonic acid-based polymer electrolyte membrane.

9. A method for controlling a direct-methanol fuel cell system comprising a power generating unit including an anode, a cathode, and an electrolyte membrane provided between the anode and the cathode, the method comprising:
reducing a concentration of a first fuel supplied to the anode and a voltage of the power generating unit until a temperature of the power generating unit rises to a preset temperature value, and the first fuel being a methanol aqueous solution.

10. The method for controlling the direct-methanol fuel cell system according to claim 9, wherein the concentration of the first fuel is reduced to a preset concentration value by alternately performing a first operation and a second operation, until the temperature of the power generating unit rises to the preset temperature value,
the first operation is one for reducing the concentration of the first fuel to a value greater than the preset concentration value, and the second operation is one for maintaining the concentration of the first fuel at the value by replenishing the first fuel with a second fuel which is methanol or a methanol aqueous solution having a concentration higher than a concentration of the first fuel.

11. The method for controlling the direct-methanol fuel cell system according to claim 10, further comprising:
obtaining an amount of methanol to be consumed in power generation until the first fuel is replenished with the second fuel in the second operation; and
correcting an amount of the second fuel to be replenished in the second operation using the amount of methanol to be consumed.

12. The method for controlling the direct-methanol fuel cell system according to claim 9, wherein the preset temperature value falls within a range of 50 to 90° C.

13. A method for controlling a direct-methanol fuel cell system comprising:
a power generating unit including at least one membrane electrode assembly;
a fuel container which is connected to the power generating unit and contains a first fuel being a methanol aqueous solution; and
a replenishing container which is connected to the fuel container and contains a second fuel which is methanol or a methanol aqueous solution having a concentration higher than a concentration of the first fuel,
and the method comprises reducing a concentration of the first fuel and a voltage of the power generating unit until a temperature of the power generating unit rises to a preset temperature value.

14. The method for controlling the direct-methanol fuel cell system according to claim 13, the direct-methanol fuel cell system further comprising an adjusting unit configured to adjust an amount of the second fuel from the replenishing container replenished in the fuel container.

15. The method for controlling the direct-methanol fuel cell system according to claim 14, wherein the concentration of the first fuel is reduced to a preset concentration value by alternately performing a first operation and a second operation, until the temperature of the power generating unit rises to the preset temperature value,
the first operation is one for reducing the concentration of the first fuel to a value greater than the preset concentration value, and the second operation is one for maintaining the concentration of the first fuel at the value by replenishing the fuel container with the second fuel in an amount adjusted by the adjusting unit.

16. The method for controlling the direct-methanol fuel cell system according to claim 15, wherein the adjusting unit is configured to calculate an amount of methanol to be consumed in power generation until the fuel container is replenished with the second fuel from the replenishing container in the second operation, and configured to correct the amount of the second fuel to be replenished in the second operation using the amount of methanol to be consumed.

17. The method for controlling the direct-methanol fuel cell system according to claim 13, wherein the preset temperature value falls within a range of 50 to 90° C.

18. The method for controlling the direct-methanol fuel cell system according to claim 13, wherein the preset temperature value falls within a range of 50 to 75° C.

19. The method for controlling the direct-methanol fuel cell system according to claim 13, wherein said at least one membrane electrode assembly comprises an anode, a cathode, and an electrolyte membrane provided between the anode and the cathode.

20. The direct-methanol fuel cell system according to claim 19, wherein the anode and the cathode contain a platinum-containing catalyst, and the electrolyte membrane is a perfluorosulfonic acid-based polymer electrolyte membrane.
